(19) United States
(12) Patent Application Publication
(10) Pub. No.: US 2004/0213191 A1
(43) Pub. Date: Oct. 28, 2004

(54) Method for transmitting frames in WLAN

(76) Inventor: Sheng-Chun Lee, Sinpu Township (TW)

Correspondence Address: SEYFARTH SHAW, 55 EAST MONROE STREET, SUITE 4200, CHICAGO, IL, 60603-5803, US

(21) Appl. No.: 10/679,068

(22) Filed: Oct. 3, 2003

(30) Foreign Application Priority Data
Apr. 24, 2003 (TW) 092109855

(51) Int. Cl. H04Q 7/24; H04J 3/24

(52) U.S. Cl. 370/338; 370/349

(57) ABSTRACT

The method for transmitting frames in WLAN of the present invention first allocates a first queue for storing frames to be transmitted in the DCF mode, and a second queue for storing frames to be transmitted in the PCF mode. An incoming frame will be classified and stored in a corresponding queue according to the classification of the incoming frame. In the DCF mode, the DCF frames stored in the first queue are transmitted. After a delivery traffic information message (DTIM) period, the transmission of the frames switches to the PCF mode and begins the transmission of the PCF frames in the second queue. In addition, the present invention can allocate a third queue for storing management frames and a fourth queue for storing multicast frames and broadcast frames. The priority for transmitting frames, from highest to lowest, is the fourth queue, the third queue, the second queue and the first queue.

### BACKGROUND OF THE INVENTION

(A) Field of the Invention

The present invention relates to a method for transmitting frames in WLAN, and more particularly, to a method for transmitting frames in WLAN using a plurality of queues.

(B) Description of the Related Art

Unlike a traditional wired local area network (LAN), a station in the architecture of the wireless LAN (WLAN) does not have to be set in a node in the architecture. Instead, the station can be moved anywhere at anytime and still have the ability to access data on the network.

IEEE 802.11 is a communication protocol for operation in WLAN wherein the Media Access Control (MAC) protocol provides two different access methods, namely Distributed Coordination Function (DCF) mode and Point Coordination Function (PCF) mode. DCF mode is the basic access method in IEEE 802.11 MAC, and allows stations to transmit and receive asynchronous data by using Carrier Sense Multiple Access (CSMA) and Collision Avoidance (CA) technique. A point coordinator controls the data access in PCF mode and arranges the time and the priority for the station to transmit frames by polling so that the station can transmit and receive time-bound data. There will be no frame collision in PCF mode since the PCF mode is contention free.

FIG. 1 is a schematic diagram showing an example for transmitting frames using a single queue 10. Frames to be transmitted in PCF mode (PCF frame) with various length and frames to be transmitted in DCF mode (DCF frame) are stored in the queue 10 in a first-in-first-out (FIFO) manner. The queue 10 must complete the transmission of the three DCF frames in DCF mode and then switches to the PCF mode to transmit the PCF frames stored in the queue 10. Likewise, the queue 10 must complete the transmission of the three DCF frames and two PCF frames, and then the management frame can be transmitted even if the management frame has higher priority than the PCF frames and the DCF frames.

The conventional single queue for transmitting frames in WLAN possesses the following problems:

1. Since the single queue must complete the transmission of frames in one mode and then switch to another mode to transmit frames, the period of the transmission mode is dependent on the length of the frame. As a result, it is impossible to set the period of the DCF mode and the PCF mode.

2. Since the transmission of frames in the single queue is based on FIFO rule, the higher priority frame, such as a management frame, will not be transmitted until the transmission of frames inputted into the queue earlier is completed. Therefore, there is no flexibility to change the sequence for transmitting frames.

Because of the above-mentioned problems with the prior art, there is a need for a new method for transmitting frames to cope with present and future technical needs.

### SUMMARY OF THE INVENTION

The objective of the present invention is to provide a method for transmitting frames in WLAN. The method uses two separated queues to store PCF frames and DCF frames, and transmits the frames in PCF mode and DCF mode, respectively, so as to fulfill the transmission in PCF mode and DCF mode as described in IEEE 802.11 MAC protocol.

The second objective of the present invention is to provide a method for transmitting frames in WLAN. The method uses three separated queues to store PCF frames, DCF frames and management frames, respectively, and can transmit these frames according to the priority of the queues.

The third objective of the present invention is to provide a method for transmitting frames in WLAN. The method uses four separated queues to store PCF frames, DCF frames, management frames and multicast frames, respectively. The method possesses the flexibility to change the sequence for transmitting frames.

To achieve the above-mentioned objectives, the present invention discloses a method for transmitting frames in WLAN. The method first allocates a first queue for storing frames to be transmitted in the DCF mode, and a second queue for storing frames to be transmitted in the PCF mode. An incoming frame will be classified and stored in a corresponding queue according to the classification of the incoming frame. In the DCF mode, the DCF frames stored in the first queue are transmitted. After a delivery traffic information message (DTIM) period, the transmission of the frames switches to the PCF mode and begins the transmission of the PCF frames in the second queue. In addition, the present invention can allocate a third queue for storing management frames. When the third queue receives a management frame, the transmission of the frames will switch to the third queue in the next transmission period to transmit the management frame. Furthermore, the present invention can also allocate a fourth queue for storing multicast frames and broadcast frames. When a DITM signal appears, the transmission of the frames switches to the fourth queue and begins to transmit the multicast frames and broadcast frames.

Compared with the prior art, the present invention has the following advantages because it uses two to four separate queues for storing and transmitting frames, respectively.

1. Since the present invention can switch from one transmission mode to another according to the DTIM period, the transmission of the PCF mode and the DCF mode, defined by IEEE 802.11 MAC protocol, is fulfilled.

2. The frames are transmitted according to the priority of the frames using a plurality of queues to store frames with different priority, respectively. The flexibility for transmitting frames is increased.

### BRIEF DESCRIPTION OF THE DRAWINGS

Other objectives and advantages of the present invention will become apparent upon reading the following description and upon reference to the accompanying drawings in which:

FIG. 1 is a schematic diagram showing an example for transmitting frames using a single queue;

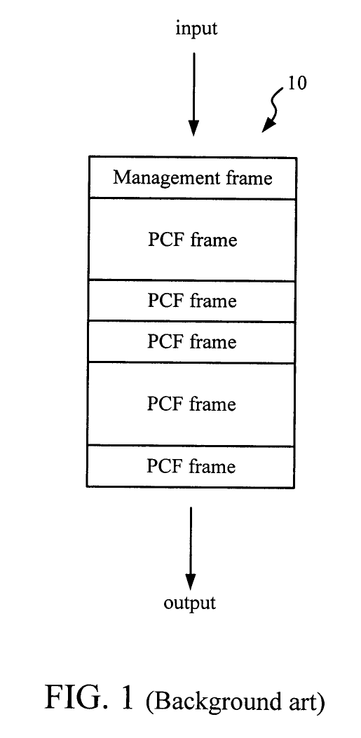

FIG. 2 is a schematic diagram showing the transmission of frames using two queues according to the present invention;

FIG. 3 is a diagram showing the operation of the two queues according to the present invention;

FIG. 4 is a schematic diagram showing the transmission of frames using three queues according to the present invention;

FIG. 5 is a diagram showing the operation of the three queues according to the present invention;

FIG. 6 is a schematic diagram showing the transmission of frames using four queues according to the present invention; and

FIG. 7 is a diagram showing the operation of the four queues according to the present invention.

### PREFERRED EMBODIMENT OF THE PRESENT INVENTION

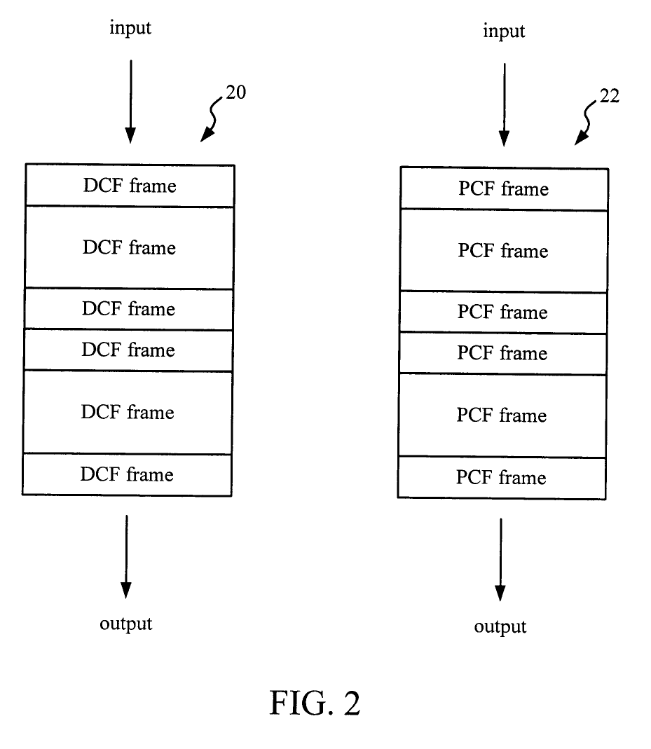

FIG. 2 is a schematic diagram showing the transmission of frames using two queues according to the present invention. As shown in FIG. 2, a DCF queue 20 (first queue) and a PCF queue 22 (second queue) are allocated according to the present invention. The DCF queue 20 is used to store DCF frames while the PCF queue 22 is used to store PCF frames. The incoming frames are classified and stored in the DCF queue 20 and the PCF queue 22 according to the classification of the incoming frames. In other words, incoming frames to be transmitted in the DCF mode will be stored in the DCF queue 20 while those to be transmitted in the PCF mode will be stored in the PCF queue 22.

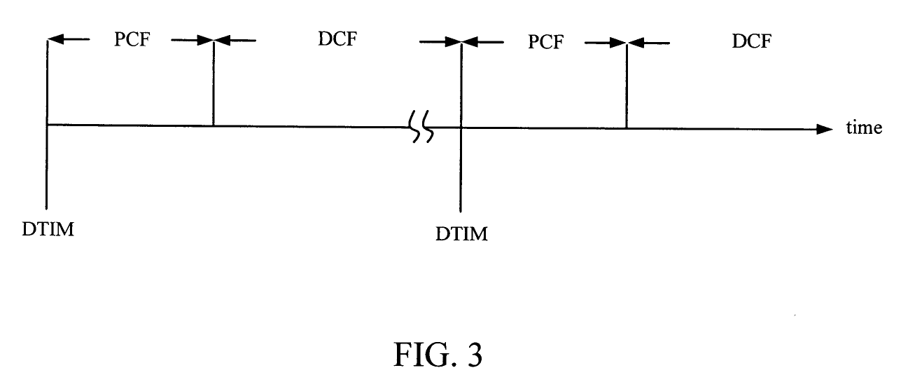

FIG. 3 is a diagram showing the operation of the two queues according to the present invention. As shown in FIG. 3, the DTIM period is set to be five beacon intervals (unit of DTIM). The PCF mode is set for two beacon intervals while the DCF mode is set for three beacon intervals. The PCF queue 22 is the initial queue and used for transmitting PCF frames. PCF frames stored in the PCF queue 22 will be transmitted in the PCF mode. After PCF mode transmission for two beacon intervals, the transmission of frames switches to the DCF mode and begins the transmission of the DCF frames stored in the DCF queue 20. After DCF mode transmission for three beacon intervals, the transmission of frames switches back to the PCF mode for transmitting the PCF frames stored in the PCF queue 22. If the PCF queue 22 is transmitting a PCF frame when it is time to switch from the PCF mode to the DCF mode for transmitting frames stored in the DCF queue 20, the transmission of frames will not switch to the DCF mode until the transmission of this PCF frame is completed, but the other PCF frames stored in the queue 22 will be suspended.

The present invention uses two separate queues to store PCF frames and DCF frames, respectively, so as to fulfill the PCF mode transmission and the DCF mode transmission, defined in the IEEE 802.11 MAC protocol, according to the DTIM period.

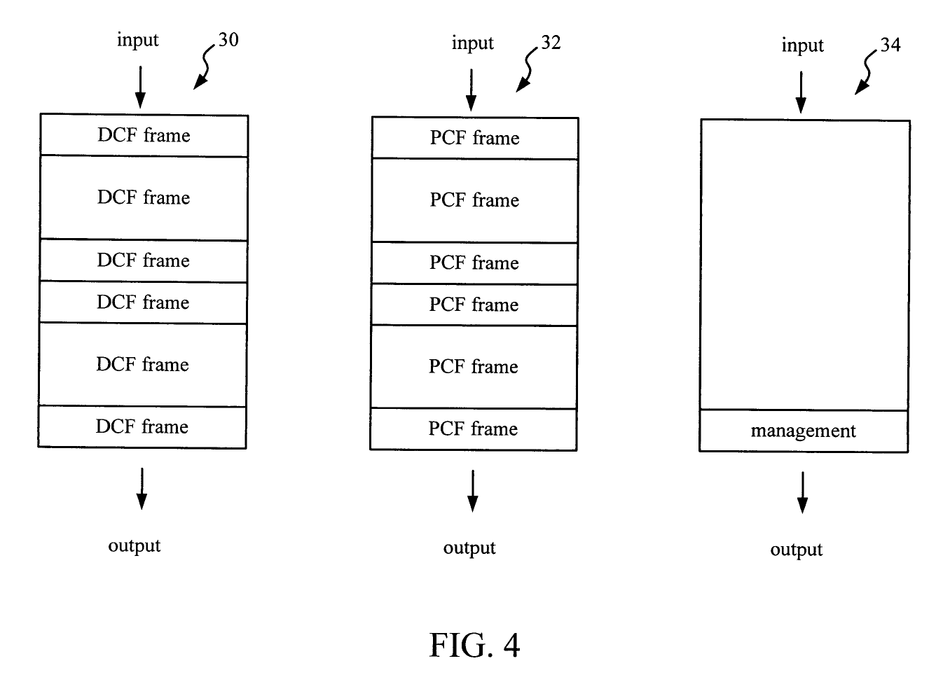

FIG. 4 is a schematic diagram showing the transmission of frames using three queues according to the present invention. As shown in FIG. 4, a DCF queue 30, a PCF queue 32, and a management queue 34 (third queue) are allocated according to the present invention. The DCF queue 30 is used to store DCF frames, the PCF queue 32 is used to store PCF frames, and the management queue 34 is used to store management frames. The incoming frames are classified and stored in the DCF queue 30, the PCF queue 32, and the management queue 34 according to the classification of the incoming frames, respectively.

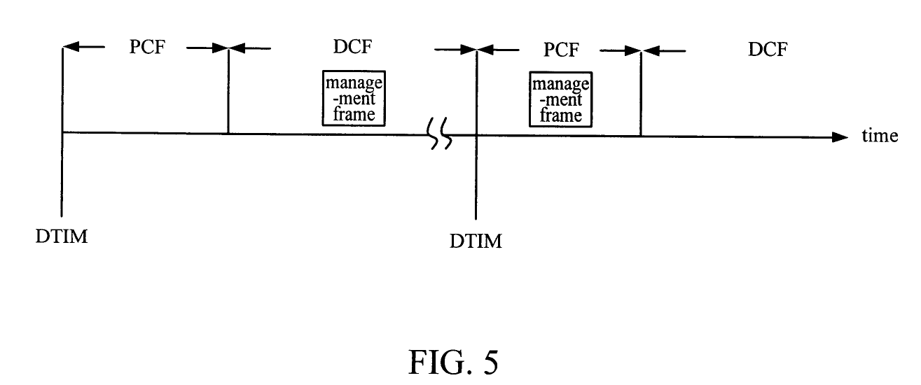

FIG. 5 is a diagram showing the operation of the three queues according to the present invention. As shown in FIG. 5, after the PCF mode transmission for two beacon intervals, the transmission of frames switches to DCF mode and begins the transmission of the DCF frames stored in the DCF queue 30. If the management queue 34 receives a management frame during the transmission of the DCF frame in the DCF mode, the transmission of frames will switch to the management queue 34 and begin to transmit the management frame after the transmission of the DCF frame is completed according to the present invention. The transmission of frames switches back to the DCF mode and continues the transmission of the DCF frames stored in the DCF queue 30 after the transmission of the management frame is completed. After DCF mode transmission for three beacons, the transmission of frames switches to the PCF mode to transmit the PCF frames stored in the PCF queue 32. If the management queue 34 receives a management frame during the transmission of a PCF frame in the PCF mode, the transmission of frames switches to the management queue 34 to transmit the management frame after the transmission of the PCF frame is completed, and then switches back to the PCF mode to continue the transmission of the PCF frames stored in the PCF queue 32.

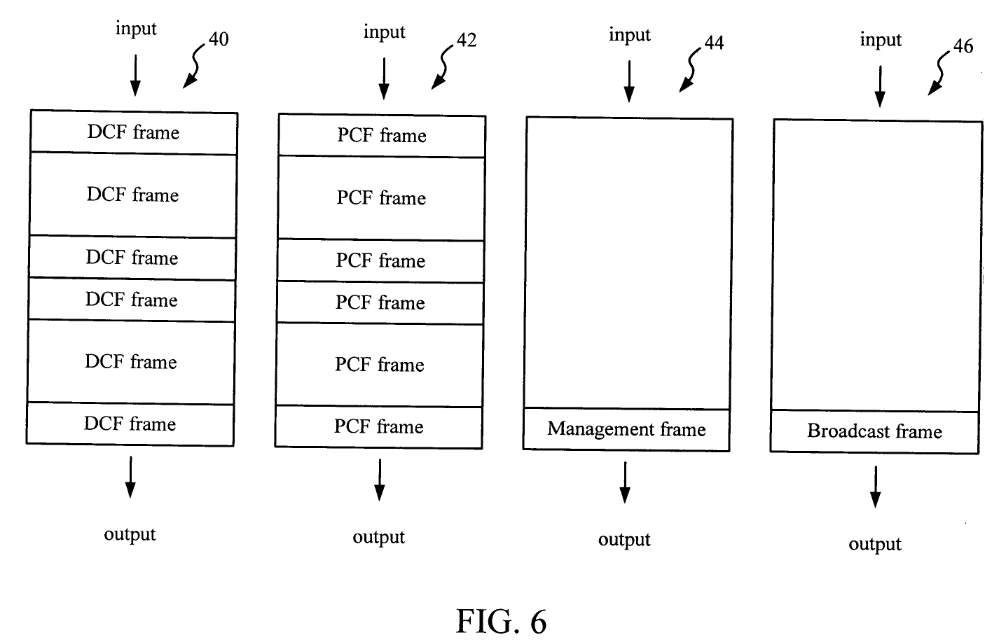

FIG. 6 is a schematic diagram showing the transmission of frames using four queues according to the present invention. As shown in FIG. 6, a DCF queue 40, a PCF queue 42, a management queue 44, and a broadcast queue 46 (fourth queue) are allocated according to the present invention. The DCF queue 40 is used to store DCF frames, the PCF queue 42 is used to store PCF frames, the management queue 44 is used to store management frames, and the broadcast queue 46 is used to store multicast frames and broadcast frames that are not transmitted since the receiving workstation is in the power-saving mode. The incoming frames are classified and stored in the DCF queue 40, the PCF queue 42, the management queue 44, and the broadcast queue 46 according to the classification of the incoming frames.

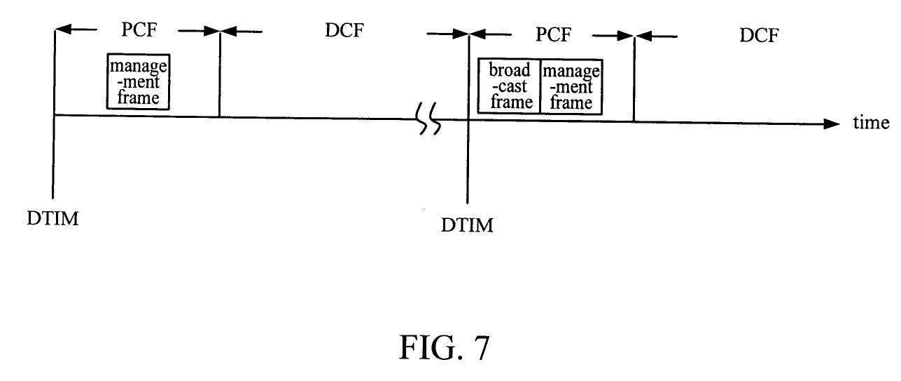

FIG. 7 is a diagram showing the operation of the four queues according to the present invention. As shown in FIG. 7, the management queue 44 receives a management frame during the transmission of a PCF frame in the PCF mode. According to the present invention, the transmission of frames switches to the management queue 44 to transmit the management frame after the transmission of the PCF frame is completed, and then switches back to the PCF mode to continue the transmission of the PCF frames stored in the PCF queue 42. Two beacons later, the transmission of frames switches to the DCF mode to transmit the DCF frames stored in the DCF queue 40. One DTIM later, the broadcast frames stored in the broadcast queue 46 will be first transmitted, and then the transmission of the management frame stored in the management queue 44 follows. The PCF frame is then transmitted because it is still in the PCF mode when the transmission of the management frame is completed. In other words, the priority, from highest to lowest, for transmitting the frames stored in the four queues is: broadcast queue 46>management queue 44>PCF queue 42>DCF queue 40.

Compared with the prior art, the present invention has the following advantages because it uses two to four separate queues for storing and transmitting frames, respectively.

1. Since the present invention can switch from one transmission mode to another according to the DTIM period, the transmission of the PCF mode and the DCF mode, defined by IEEE 802.11 MAC protocol, is fulfilled.

2. The frames are transmitted according to the priority of the frames using a plurality of queues to store frames with different priority. The flexibility for transmitting frames is increased.

The above-described embodiments of the present invention are intended to be illustrative only. Numerous alternative embodiments may be devised by those skilled in the art without departing from the scope of the following claims.

What is claimed is:

1. A method for transmitting frames in a wireless local area network, comprising the steps of:
providing a plurality of queues and assigning each queue a priority level;
receiving a plurality of frames and storing the frames in corresponding queues based on the type of the frames; and
transmitting the frames stored in the plurality of queues according to the priority level of each queue.

2. The method for transmitting frames in a wireless local area network of claim 1, wherein a transmitting period is set for alternately transmitting the frames stored in the plurality of queues.

3. The method for transmitting frames in a wireless local area network of claim 2, wherein the plurality of queues comprise:
a first queue for storing frames to be transmitted in a distributed coordination function (DCF) mode; and
a second queue for storing frames to be transmitted in a point coordination function (PCF) mode.

4. The method for transmitting frames in a wireless local area network of claim 3, wherein the plurality of queues further comprise a third queue for storing management frames.

5. The method for transmitting frames in a wireless local area network of claim 4, wherein the third queue obtains the right for transmitting frames in the next transmission period once receiving a management frame.

6. The method for transmitting frames in a wireless local area network of claim 4, wherein the plurality of queues further comprise a fourth queue for storing multicast and broadcast frames.

7. The method for transmitting frames in a wireless local area network of claim 6, wherein the fourth queue is used to store multicast and broadcast frames which are not received by stations in a power-saving mode.

8. The method for transmitting frames in a wireless local area network of claim 6, wherein the fourth queue obtains the right for transmitting frames in the next transmission period once a delivery traffic information message (DTIM) appears.

9. The method for transmitting frames in a wireless local area network of claim 6, wherein the priority levels for transmitting frames, from highest to lowest, are the fourth queue, the third queue, the second queue and the first queue.
